(19) United States
(12) Patent Application Publication
(10) Pub. No.: US 2018/0095469 A1
(43) Pub. Date: Apr. 5, 2018

(54) AUTONOMOUS SYSTEM FOR SHOOTING MOVING IMAGES FROM A DRONE, WITH TARGET TRACKING AND HOLDING OF THE TARGET SHOOTING ANGLE

(71) Applicant: PARROT DRONES, Paris (FR)

(72) Inventor: Edouard LEURENT, Paris (FR)

(21) Appl. No.: 15/726,337

(22) Filed: Oct. 5, 2017

(30) Foreign Application Priority Data
Oct. 5, 2016 (FR) 1659605

(51) Int. Cl. G05D 1/00

(52) U.S. Cl. CPC G05D 1/0094; B64D 47/08

(57) ABSTRACT

A system for shooting moving images includes a drone provided with a camera and a ground station, the camera being directed along a sight axis, the drone being adapted to fly autonomously to shoot moving images of a target moving with the ground station, the direction of the sight axis being such that the target remains present in the successive images produced by said shooting. The system further comprises means for determining the speed vector of the target and the position of the target in a given reference system, and control means configured to generate flight instructions based on the speed vector determined, the position determined, and a predetermined direction angle so as to hold the angle between the sight axis of the camera and the direction of the speed vector substantially at the value of said predetermined direction angle.

### CROSS REFERENCE TO RELATED APPLICATIONS

This application claims priority under 35 U.S.C. § 119(a) to French Patent Application Serial Number 1659605, filed Oct. 5, 2016, the entire teachings of which are incorporated herein by reference.

### BACKGROUND OF THE INVENTION

### Field of the Invention

The invention relates to the remote-piloted flying motorized devices, hereinafter generally called “drones”, and more specifically to rotary-wing drones, namely quadricopters, which is a drone equipped with a series of sensors (accelerometers, three-axis gyrometers, altimeter), a front camera capturing an image of the scene towards which the drone is directed, and a vertical-view camera capturing an image of the overflown terrain.

### Description of the Related Art

Rotary-wing drones are provided with multiple rotors driven by respective motors able to be controlled in a differentiated manner in order to pilot the drone in attitude and speed. Published Patent Cooperation Treaty Request WO 2010/061099 A2 and Published European Patent Application EP 2364757 A1 describe such a drone as well as the principle of piloting thereof by means of a station, generally at the ground, such as a touch-screen multimedia telephone or player with an integrated accelerometer, for example a cellular phone or a multimedia tablet. These stations incorporate the various control elements required for the detection of the piloting commands and the bidirectional exchange of data with the drone via a radio link of the Wi-Fi (IEEE 802.11) or Bluetooth wireless local network type. They are further provided with a touch screen displaying the image captured by the front camera of the drone, with in superimposition a number of symbols allowing the activation of commands by simple contact of the user's finger on this touch screen.

The front video camera of the drone may be used to capture sequences of images of a scene towards which the drone is directed. The user can hence use the drone in the same way as a camera or a camcorder that, instead of being held in hand, would be borne by the drone. The images collected can be recorded then broadcasted, put online on video sequence hosting web sites, sent to other Internet users, shared on social networks, etc.

The front camera may be a steerable camera, in order to direct in a controlled manner in a predetermined direction the sight axis, and hence the field of the images transmitted with the video stream. A technique implemented in particular in the above-mentioned BEBOP 2 device and described in the Published European Patent Application EP 2933775 A1 utilizes a high-definition wide-angle camera provided with a hemispherical-field lens of the fisheye type covering a field of about 180° and in windowing in current time the raw image delivered by this sensor, by a software processing ensuring the selection of the useful pixels of the raw image in a determined capture zone as a function of a certain number of parameters, including commands of pointing towards a particular target chosen by the user or automatically tracked by the drone. As a variant, or even as a complement, of the control of the camera sight axis by a windowing software program, it is also possible to mount the camera on a three-axis articulated support of the gimbal type with Cardan suspension, provided with servomotors piloted as a function of the gyrometer data and of the pointing commands. The invention applies of course to any type of camera, steerable or not, and whatever the pointing mode thereof.

In a so-called tracking mode, the drone can be programmed to track a mobile target whose coordinates are known and so that, during the flight, the sight axis of the camera is directed towards said target. This target is typically the station itself, carried by a user who may be in motion (for example, practicing a sport in which he moves—running, sliding, driving, etc.). In this mode, the drone is capable of filming the movements of the user without the latter has to act on the displacements of the drone and on the sight axis of the camera.

The drone tracking the target object adjusts its position and/or the position of the camera unit so that the target object is always filmed by the drone. The drone being autonomous, i.e. the displacement is calculated by the drone and not piloted by a user, it determines its trajectory as a function of the movements of the target object and controls the camera unit so that the latter is always directed towards the target object to be filmed. Hence, when the target moves, the drone is not only able to track the target, but it also positions itself so as to steer the camera in such a manner that the sight axis thereof points towards the target.

For that purpose, the coordinates of the ground station, obtained by a GPS unit equipping the latter in a manner known per se, are communicated to the drone through the wireless link, and the drone can hence adjust its displacements so as to track the target and so that the sight axis of the camera remains directed towards the target, in order for the image to hence remain centred to the subject.

In tracking mode, it is known that the drone tracks the displacement of the target that is in the field of view of the camera. Hence, when the target follows a trajectory that goes away from the drone, the latter detects the movement of the target and moves itself towards the target so that the latter remains in the field of view of the camera. In this method, the drone comes in position rear the target to track the moving away of the latter. Images with a rear view of the target are hence obtained. Moreover, the image shooting angle is modified during the displacement of the target. Indeed, when the target performs a turn whereas the drone is tracking it, the drone ends up rear the target or in front of it according to the turn direction. Hence, the shooting angle of the camera with respect to the trajectory of the target is very different from that before the turn.

### BRIEF SUMMARY OF THE INVENTION

An object of the invention is to propose a system allowing a drone, in an autonomous shooting mode for shooting a target in motion, on the one hand, to keep a same target shooting angle during the tracking, and on the other hand, to hold the relative positioning of the drone about the target.

The invention proposes for that purpose a system for shooting moving images, comprising a drone provided with a camera and a ground station communicating with the drone through a wireless link, the camera being directed along a sight axis, the displacements of the drone being defined by flight instructions applied to a propulsion unit or a set of propulsion units of the drone, the drone being adapted to fly autonomously to shoot moving images of a target moving with the ground station, the direction of the sight axis being such that the target remains present in the successive images produced by said shooting.

Characteristically of the invention, the system includes:
means for determining the speed vector of the target and the position of the target in a given reference system, and
control means configured to generate said flight instructions based on:

a) the speed vector determined,

b) the position determined, and

c) a predetermined direction angle,
so as to hold the angle between the sight axis of the camera and the direction of the speed vector substantially to the value of said predetermined direction angle (□ₚ).

The following characteristics may be taken together or separately.

Preferably, the system includes means for activating the target tracking by the drone, adapted to:
control the activation of the target tracking, and
calculate the value of said predetermined direction angle at the time of said activation.

The flight instructions generated by the control means may be generated based on a feedback loop on a command for holding the predetermined direction angle.

Also preferably, the control means are configured to generate the flight instructions to further control the displacement of the drone at a predetermined distance between the drone and the target.

In a preferential embodiment, the means for activating the target tracking by the drone are further adapted to calculate the value of the predetermined distance at the time of said activation.

The flight instructions generated by the control means may be further generated based on a feedback loop on a command for holding said predetermined distance.

Preferably, the control means are configured to generate the flight instructions to further control the displacement of the drone so as to hold a predetermined elevation angle, the predetermined elevation angle being an angle between the sight axis of the camera and a horizontal plane.

In a preferred embodiment, the means for activating the target tracking by the drone are further adapted to calculate the value of the predetermined elevation angle at the time of said activation.

The flight instructions generated by the control means may be further generated based on a feedback loop on a command for holding the predetermined elevation angle.

In a particular embodiment, the direction of the sight axis of the camera is fixed with respect to a main axis of the drone, the control means being configured to generate flight instructions so as to direct the sight axis of the camera towards the target during the tracking of the target by the drone.

In another particular embodiment, the direction of the sight axis of the camera is modifiable with respect to a main axis of the drone thanks to modification means, the modification means being configured to direct at least in part the sight axis of the camera towards the target during the tracking of the target by the drone.

The means for determining the speed vector and the position of the target may operate by observation of the successive GPS geographical positions of the target, the given reference system being a terrestrial reference system.

The means for determining the speed vector and the position of the target may operate by analysis of the images delivered by the camera of the drone, the given reference system being a reference system linked to the drone.

In this case, the analysis of the images delivered by the camera is preferably an analysis of the position of the target in the images successively generated by the camera of the drone, and the system comprises means for locating and tracking said position in the successive images.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic overall view of a shooting system comprising a drone and a ground station.

FIG. 2 is schematic representation of a top view of the system of FIG. 1 according to the invention, the target and the drone being each represented in an initial position and in a later position.

FIG. 3 is schematic representation of the means implemented in the system of FIG. 1.

FIG. 4 is schematic representation of a side view of the system of FIG. 1 according to the invention, the target and the drone being each represented in an initial position and in a later position.

### DETAILED DESCRIPTION OF THE INVENTION

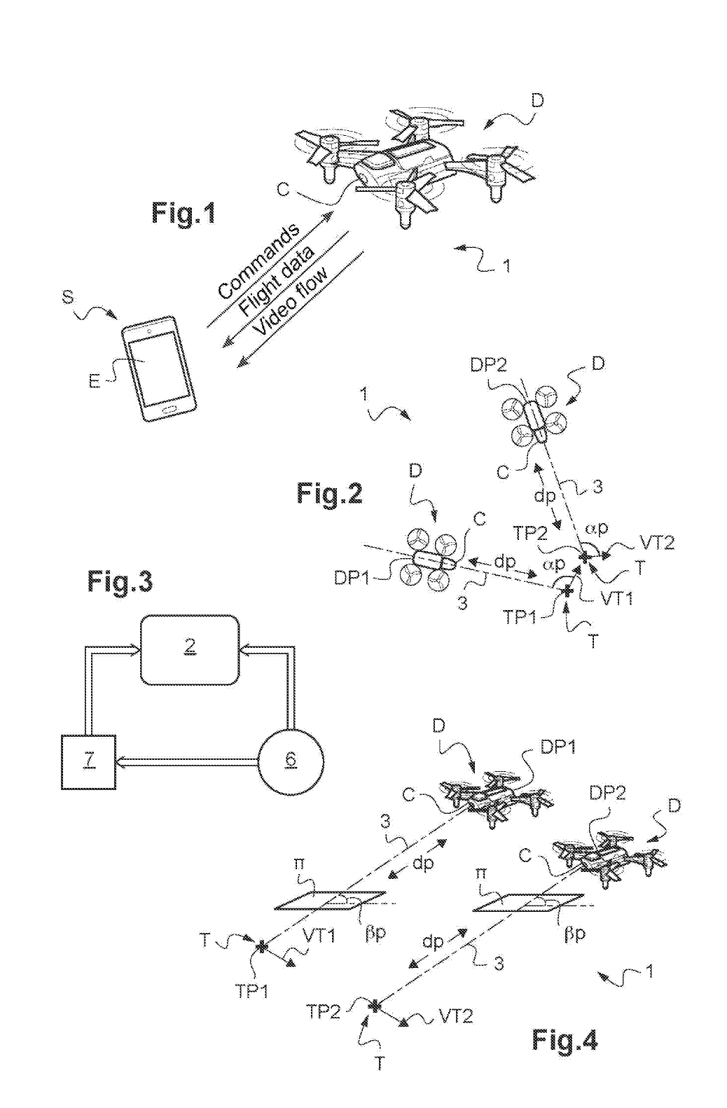

The invention applies to a drone D, for example a drone of the quadricopter type and relates to a system 1 for shooting moving images. The system includes a drone D provided with a camera C and a ground station S communicating with the drone D through a wireless link, shown in FIG. 1. The drone D includes a propulsion unit or a set of propulsion units comprising coplanar rotors whose motors are piloted independently by an integrated navigation and attitude control system. It is provided with a front-view camera C allowing obtaining an image of the scene towards which the drone D is directed. The camera C is directed along a sight axis 3, as shown in FIG. 2.

Inertial sensors (accelerometers and gyrometers) allow measuring with a certain accuracy the angular speeds and the attitude angles of the drone, i.e. the Euler angles (pitch, roll and yaw) describing the inclination of the drone with respect to a horizontal plane of a fixed terrestrial reference system. An ultrasonic range finder placed under the drone D moreover provides a measurement of the altitude with respect to the ground. The drone D is also provided with location means allowing determining its absolute position DP1, DP2 in space, in particular based on data coming from a GPS receiver.

The drone D is piloted by the ground station S, typically in the form of a remote-control device, for example of the model aircraft remote-control type, a smartphone or a smart tablet. The smartphone or the smart tablet is provided with a touch screen E displaying the image inside the front camera C, with, in superimposition, a certain number of symbols allowing the activation of piloting commands by simple contact of a user's finger on the touch screen E. When the drone D is piloted by a station S of the remote-control type, the user may be provided with immersive piloting glasses, often called FPV (“First Person View”) glasses. The station S is also provided with means for radio link with the drone D, for example of the Wi-Fi (IEEE 802.11) local network type, for the bidirectional exchange of data from the drone D to the station S, in particular for the transmission of the image captured by the camera C and of flight data, and from the station S to the drone D for the sending of piloting commands.

The system consisted by the drone D and the station S is configured so that the drone is provided with the ability to autonomously track and film a target. Typically, the target is consisted by the station S itself carried by the user.

According to the invention, the tracking of the target by the drone is performed by keeping the same target shooting angle for the camera C of the drone D. The displacements of the drone D are defined by flight instructions generated by control means of the navigation system of the drone D, and applied to the propulsion unit or to the set of propulsion units of the drone D.

According to the invention illustrated in FIGS. 2 and 3, to keep the same target shooting angle on the successive images, the instructions of the control means 2 are generated so as to hold a predetermined direction angle αₚ formed between the sight axis 3 of the camera C and the direction of the speed vector VT1, VT2 of the target T. This angle corresponds substantially to the target shooting angle of the camera C of the drone D. It is determined, at a given instant, a value, for example fixed, of the predetermined direction angle αₚ, which is substantially held in the mode in which the drone D tracks the target T. In other words, the drone D follows a displacement as a function of the displacement of the target T so that the current direction angle α is substantially equal to the value of the predetermined direction angle αₚ during respective displacements of the target T and of the drone D. Hence, the predetermined direction angle αₚ is the angle according to which it is desired to perform the continuous shooting of the target T. According to another embodiment, the value of the predetermined direction angle αₚ may be chosen among a set of values pre-recorded in the system 1.

For that purpose, the control means 2 of the system are configured to generate said flight instructions based on:

the speed vector VT1, VT2 of the target T,

the position of the target TP1, TP2, and

a predetermined direction angle □ₚ.

The direction of the sight axis 3 of the camera of the drone is such that the target T remains present on the successive images produced by said shooting.

In a first embodiment, the direction of the sight axis 3 of the camera C is fixed with respect to a main axis of the drone. The control means 2 are hence configured to generate flight instructions so as to position the main axis of the drone in such a manner that the sight axis 3 of the camera C is directed towards the target T during the tracking of the target T by the drone D.

In a second embodiment, the direction of the sight axis 3 of the camera C is modifiable with respect to a main axis of the drone thanks to modification means. The modification means are configured to direct at least in part the sight axis 3 of the camera towards the target T during the tracking of the target by the drone D. The camera C is for example a fixed camera of the hemispherical-field, fisheye type, as described for example in the EP 2 933 775 A1 (Parrot). With such a camera, the changes of the sight axis 3 of the camera C are not performed by physical displacement of the camera, but by reframing and reprocessing of the images taken by the camera as a function of a virtual sight angle, determined with respect to the main axis of the drone, given as a command. The camera C may also be a mobile camera assembled to the drone, for example under the drone body, in this case, the modification means comprise motors to rotate the camera about at least one of the three axes, or even the three axes, in order to direct the sight axis of the camera in such a way that the target remains present in the successive images produced by said shooting.

The coordinates of the position TP1, TP2 of the target T allow determining the direction of the sight axis 3 of the camera C so that the target T remains present on the successive images produced during the shooting. The coordinates of the sight axis 3 of the camera C are determined thanks to the sensors of the drone, that determine the position of the drone D.

The coordinates of the speed vector VT1, VT2 and the position TP1, TP2 of the target T with respect to the drone D allow determining the current direction angle α between the sight axis 3 of the camera C and the direction of the speed vector VT1, VT2.

The control means 2 are for example configured to generate said flight instructions based on a feedback loop on a command for holding said predetermined direction angle αₚ, for example by means of a computing unit provided with an execution program provided for that purpose. The principle of the feedback control is to continuously measure the difference between the current value of the quantity to be controlled and the predetermined value that is desired to be reached, to determine the suitable control instructions to reach the predetermined value. Hence, the control means 2 first determine the current direction angle α, then give flight instructions so that the drone D moves to a position DP2 in which the current direction angle α corresponds to the predetermined direction angle αₚ. The feedback loop is repeated in continuous by the control means 2 to hold the value of the predetermined direction angle □ₚ.

With reference to FIG. 2, the drone D has been schematically shown in autonomous motion, equipped with the camera C that takes a sequence of moving images of the target T. The target T has an initial position TP1 and the drone D has an initial position DP1, defined in the terrestrial reference system. The target D moves with a speed vector VT1 to the position DP1, and VT2 to the position DP2, the direction and the value changing over time. In the initial position DP1, the axis of the camera C is directed towards the target T and forms a direction angle with the direction of the speed vector VT1, which corresponds to the predetermined direction angle αₚ. In the same FIG. 2, the target is shown in a later position TP2 and the drone in a later position DP2. The target T passes from the initial position TP1 to the later position TP2. In the tracking mode, the drone D moves from the initial position DP1 to the later position DP2, thanks to flight instructions generated by the control means. The flight instructions are defined so as to keep the same predetermined direction angle αₚ as that of the initial positions. Hence, in their respective later positions TP2, DP2, it is observed that the direction angle formed between the sight axis 3 of the camera C and the direction of the speed vector VT2 is substantially identical to that which was defined in the initial positions TP1, DP1 of the target T and the drone D. Hence, thanks to the system 1 of the invention, the target T shooting angle of the camera C remains the same despite the displacements of the target T and of the drone D.

As shown in FIGS. 2 and 3, and in order to allow the control means 2 to calculate the current directional angle α, the system 1 further comprises means 6 for determining the position TP1, TP2 and the speed vector VT1, VT2 of the target T in a given reference system. The determination means 6 transmit the coordinates of the speed vector VT1, VT2 and of the position TP1, TP2 of the target T to the control means 2. The determination means 6 determine these coordinates repeatedly to transmit updated values to the control means 2.

In a first embodiment, said means 6 for determining the speed vector VT1, VT2 and the position of the target T operate by observation of the successive GPS geographical positions of the target T. The given reference system allowing the determination of the speed vector VT1, VT2 and of the position TP1, TP2 of the target T is hence a terrestrial reference system. The determination means 6 receive the successive GPS positions of the target T over time. The determination means 6 can hence deduce therefrom the coordinates of the speed vector VT1, VT2 of the target T. The position of the target T is given by the GPS coordinates of the ground station.

According to a first variant of this first embodiment, the determination means 6 are arranged in the drone D. The GPS positions of the target T are transmitted by the target T to the determination means 6 of the drone D.

According to a second variant of this first embodiment, the determination means 6 are arranged in the ground station of the target T. Herein, the coordinates of the speed vector VT1, VT2 and of the position TP1, TP2 of the target T are determined in the ground station, then transmitted to the drone D.

In a second embodiment, said means 6 for determining the speed vector VT1, VT2 and the position of the target T operate by analysis of the images delivered by the camera C of the drone T. The given reference system is herein a reference system linked to the drone D. In this case, the analysis of the images delivered by the camera C is an analysis of the position TP1, TP2 of the target T in the images successively generated by the camera C of the drone D. The determination means 6 comprise means for locating and tracking the position TP1, TP2 of the target T in the successive images. In this particular embodiment, the determination means 6 are located in the drone D. For that purpose, an image analysis program provided in the determination means 6 on board the drone D, or in a dedicated circuit, is configured to track the displacement of the target T in the sequence of images generated by the camera C, and to deduce therefrom in which angular direction is the target T with respect to the sight axis 3 of the camera C. More precisely, this program is configured to locate and track in the successive images a visual pattern or a colour spot representative of the visual aspect of the target with respect to a bottom (for example, a pattern elaborated by analysis of the grey levels of the image). For example, for the shooting of a target user practicing a snow sport, the bottom will be generally white and the colour of the spot in the images will be that of the user's clothes. This approach moreover allows having angular position data of the user to be tracked at a rate substantially faster than that at which the GPS coordinates are delivered (generally once per second), i.e. the rate of the images is typically of 30 frames per second for this type of application.

In this second embodiment, the image analysis is associated with another measuring means that provides at least in part a geographical position TP1, TP2 of the target T. These means may in particular come from the GPS unit of the ground station, or a pressure sensor of the barometric type, arranged in the ground station of the target T. The means for determining the sight axis 3 of the camera C being capable of indicating an angular position of the target T with respect to the main axis of the drone, are hence completed by the taking into account of a geographical signal. The electronics on board the drone is capable of knowing by cross-checking between the geographical data and the angular detection data, the position of the target T. Very accurate coordinates of the position TP1, TP2 and of the speed vector VT1, VT2 of the target T are hence obtained.

According to a particular embodiment, the control means 2 are further configured to generate said flight instructions to control the displacement of the drone D at a predetermined distance dₚ between the drone D and the target T. In other words, in the tracking mode, the distance d between the target T and the camera C is held, in addition to the holding of the shooting angle of the camera C. The predetermined distance dₚ has a fixed value during the tracking. Hence, the perception of the dimensions of the target T remains substantially the same during the shooting, with a constant focal length for the camera C. The current distance d between the target T and the camera C is calculated by the control means 2, based on the position of the target TP1, TP2 determined by the determination means 6 and by the position of the drone DP1, DP2 determined by its inertial sensors.

The control means 2 are for example configured to generate flight instructions based on a feedback loop on a command for holding said predetermined distance dₚ. The method is similar to that relating to the feedback loop on the command for holding the predetermined direction angle αₚ. The control means 2 calculate the current distance d and generate instructions to displace the drone to a position DP2 whose distance with the target T corresponds to the predetermined distance dₚ. Hence, the distance between the later positions TP2, DP2 of the drone D and of the target T of FIG. 3 is substantially identical to the distance between the initial positions TP1, DP1 of the drone D and of the target T.

According to a particular embodiment, shown in FIGS. 2 and 4, the control means 2 are further configured to generate flight instructions to control the displacement of the drone D so as to hold a predetermined elevation angle βₚ defined between the sight axis 3 of the camera C and the horizontal plane π. This predetermined elevation angle βₚ allows determining the relative altitude of the drone with respect to the target. By holding a constant predetermined elevation angle βₚ, the drone D holds its altitude relative to the target T. The horizontal plane π is defined with respect to the terrestrial reference system, and may be defined at any altitude. The value of the current elevation angle β is determined by the control means 2 as a function of the sight axis 3 of the camera C and of the horizontal plane π.

The control means 2 are for example configured to generate the flight instructions based on a feedback loop on a command for holding said predetermined direction angle βₚ. The method is similar to that relating to the feedback loop on the command for holding the predetermined direction angle αₚ and that for the predetermined distance dₚ between the camera C and the target T. Hence, as shown in FIG. 4, the current elevation angle β with respect to the horizontal plane π has the same value between the initial positions TP1, DP1 of the target T and of the drone D, and the later positions TP2, DP2.

In a particular embodiment, the control means are configured to generate flight instructions allowing modifying the position of the drone to modify simultaneously the current direction angle α, the current distance d between the camera C and the target T and the current elevation angle β to reach the three corresponding predetermined values.

In the embodiment shown in FIG. 2, the system 1 comprises means 7 for activating the tracking of the target by the drone. The tracking activation means 7 are adapted to control the activation and the deactivation of the tracking of the target T. The activation means are for example arranged in the ground station to be easily activatable by the user, and include for example an activation button. Hence, when the user operates the button, the drone passes in the target tracking mode.

According to a particular embodiment of the invention, the means 7 for activating the tracking of the target by the drone are adapted to calculate at least the value of said predetermined direction angle at the time of said activation. In other words, the activation means 7 define the value of the predetermined direction angle αₚ that will be held during the tracking of the target by the drone. The activation means 7 are for example configured so that the value of the predetermined direction angle is the current direction angle at the time of the activation, in particular at the time where the button is operated.

The activation means 7 calculate the current direction angle as a function of the coordinates of the speed vector and of the position of the target, that are transmitted to it by the determination means 6. Hence, the user positions the drone and the camera according to a sight angle he desires to hold, and activates the tracking mode thanks to the activation means 7 so that the drone tracks the target by keeping the chosen sight angle.

According to a particular embodiment, the means 7 for activating the tracking of the target by the drone are adapted to also calculate the value of the predetermined distance dₚ between the target and the drone at the time of said activation. Similarly, the activation means 7 are for example adapted to calculate the value of said predetermined elevation angle βₚ at the time of said activation. The predetermined values are transmitted to the control means 2 that record them in a memory. Hence, when the activation means 7 are operated, the values of the three predetermined parameters are calculated by the activation means 7, then held during the tracking of the target by the control means 2 as long as the user has not deactivated the tracking of the target T.

1. A system for shooting moving images, comprising:
a drone provided with a camera and a ground station communicating with the drone through a wireless link, the camera being directed along a sight axis, the displacements of the drone being defined by flight instructions applied to a propulsion unit or a set of propulsion units of the drone, the drone being adapted to fly autonomously to shoot moving images of a target moving with the ground station, the direction of the sight axis being such that the target remains present in the successive images produced by said shooting,
wherein the system additionally comprises:
means for determining the speed vector of the target and the position of the target in a given reference system, and
control means configured to generate said flight instructions based on:
the speed vector determined,
the position determined, and
a predetermined direction angle (αₚ),
so as to hold the angle between the sight axis of the camera and the direction of the speed vector substantially to the value of said predetermined direction angle.

2. The system according to claim 1, further comprising means for activating the tracking of the target by the drone adapted to:
control the activation of the tracking of the target and
calculate the value of said predetermined direction angle at the time of said activation.

3. The system according to claim 1, wherein said flight instructions generated by the control means are generated based on a feedback loop on a command for holding said predetermined direction angle.

4. The system according to claim 1, wherein the control means are configured to generate said flight instructions to further control the displacement of the drone at a predetermined distance between the drone and the target.

5. The system according to claim 2, wherein:
the control means are configured to generate said flight instructions to further control the displacement of the drone at a predetermined distance between the drone and the target; and,
the means for activating the tracking of the target by the drone are further adapted to calculate the value of said predetermined distance at the time of said activation.

6. The system according to claim 4, wherein said flight instructions generated by the control means are further generated based on a feedback loop on a command for holding said predetermined distance.

7. The system according to claim 1, wherein the control means are configured to generate said flight instructions to further control the displacement of the drone so as to hold a predetermined elevation angle, the predetermined elevation angle being an angle between the sight axis of the camera and a horizontal plane.

8. The system according to claim 7 when depending on claim 2, characterized in that the means for activating the tracking of the target by the drone are further adapted to calculate the value of said predetermined elevation angle at the time of said activation.

9. The system according to claim 7, wherein said flight instructions generated by the control means are further generated based on a feedback loop on a command for holding said predetermined elevation angle.

10. The system according to claim 1, wherein the direction of the sight axis of the camera is fixed with respect to a main axis of the drone, the control means being configured to generate flight instructions so as to direct the sight axis of the camera towards the target during the tracking of the target by the drone.

11. The system according to claim 1, wherein the direction of the sight axis of the camera is modifiable with respect to a main axis of the drone thanks to modification means, the modification means being configured to direct at least in part the sight axis of the camera towards the target during the tracking of the target by the drone.

12. The system according to claim 1, wherein said means for determining the speed vector and the position of the target operate by observation of the successive GPS geographical positions of the target, the given reference system being a terrestrial reference system.

13. The system according claim 1, wherein said means for determining the speed vector and the position of the target operate by analysis of the images delivered by the camera of the drone, the given reference system being a reference system linked to the drone.

14. The system according to claim 13, wherein the analysis of the images delivered by the camera is an analysis of the position of the target in the images successively generated by the camera of the drone, and in that it comprises means for locating and tracking said position in the successive images.
